(19) United States
(12) Patent Application Publication
(10) Pub. No.: US 2013/0189610 A1
(43) Pub. Date: Jul. 25, 2013

(54) SHORT WAVELENGTH PHOTOCONDUCTIVE MEMBERS

(71) Applicants: Cuong Vong, Hamilton (CA); Jennifer A. Coggan, Kitchener (CA); Gregory M. McGuire, Oakville (CA)

(72) Inventors: Cuong Vong, Hamilton (CA); Jennifer A. Coggan, Kitchener (CA); Gregory M. McGuire, Oakville (CA)

(73) Assignee: XEROX CORPORATION, Norwalk, CT (US)

(21) Appl. No.: 13/354,499

(22) Filed: Jan. 20, 2012

(51) Int. Cl. G03G 15/00

(52) U.S. Cl. 430/56; 399/159

(57) ABSTRACT

There is provided a photoconductive member comprising a conductive support and disposed thereon a charge generating layer. The charge generating layer comprises a first polymer binder and a perylene-tetracarbonic acid amide pigment having blue wavelength photosensitivity of the following formula:

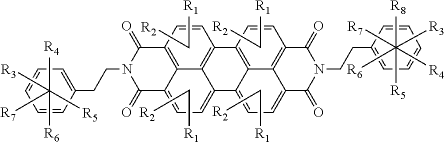

wherein each of R₁, R₂, R₃, R₄, R₅, R₆ and R₇ are the same or different and are independently selected from the group comprising hydrogen, alkyl, aryl and halogen. A charge transport layer is disposed on the conductive support and comprises tri-p-toylamine and 1,-1-bis(N,N-ditoyl-4-aminophenyl)cyclohexane in a second polymer binder.

### BACKGROUND

1. Field of Use

This disclosure is generally directed to layered imaging members, photoreceptors, photoconductors, and the like, and especially photoreceptors used in short or blue wavelength xerographic machines.

2. Background

There is a renewed interest in realizing the potential of blue laser based xerographic engines to achieve higher print resolutions. There is renewed activity around developing new blue laser based photoreceptor designs and short wavelength pigments.

U.S. Pat. Nos. 7,514,192 and 7,473,785, which are incorporated in their entirety herein, describe device designs comprising alternative short wavelength pigments. However there is need to expand the pigments available for use in short wavelength applications.

Photoconductive or photoresponsive imaging members are disclosed in the following U.S. patents, the disclosures of each of which are totally incorporated by reference herein, U.S. Pat. Nos. 4,265,990, 4,419,427, 4,429,029, 4,501,906, 4,555,463, 4,587,189, 4,709,029, 4,714,666, 4,937,164, 4,968,571, 5,019,473, 5,225,307, 5,336,577, 5,473,064, 5,645,965, 5,756,245, 6,051,351, 6,194,110, and 6,656,651. The appropriate components and process aspects of each of the foregoing U.S. patents may be selected for the present disclosure in embodiments thereof.

### SUMMARY

Disclosed herein is a photoconductive member comprising a conductive support and disposed thereon a charge generating layer. The charge generating layer comprises a first polymer binder and a perylene-tetracarbonic acid amide pigment having blue wavelength photosensitivity of the following formula:

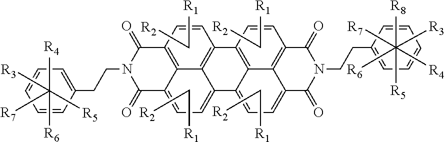

wherein each of R₁, R₂, R₃, R₄, R₅, R₆ and R₇ are the same or different and are independently selected from the group comprising hydrogen, alkyl, aryl and halogen. A charge transport layer is disposed on the conductive support and comprises tri-p-toylamine and 1,-1-bis(N,N-ditoyl-4-aminophenyl)cyclohexane in a second polymer binder.

Disclosed herein is a photoconductive member comprising a conductive support and disposed thereon a charge generating layer. The charge generating layer includes a perylene-tetracarbonic acid amide pigment shown in the formula below:

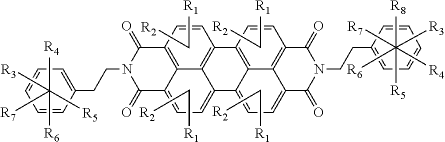

wherein each of R₁, R₂, R₃, R₄, R₅, R₆ and R₇ are the same or different and are independently selected from the group comprising hydrogen, alkyl, aryl and halogen. A charge transport layer comprising tri-p-toylamine and 1,-1-bis(N,N-ditoyl-4-aminophenyl)cyclohexane is disposed on the charge generating layer.

There is provided herein an image forming apparatus for forming images on a recording medium. The image forming apparatus includes a photoreceptor member having a charge retentive surface to receive an electrostatic latent image thereon. The photoreceptor member comprises a supporting substrate and thereover a charge generating layer comprising a perylene-tetracarbonic acid amide pigment having blue wavelength sensitivity shown in the formula:

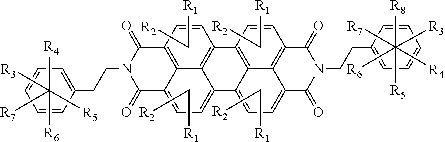

wherein each of R₁, R₂, R₃, R₄, R₅, R₆ and R₇ are the same or different and are independently selected from the group comprising hydrogen, alkyl, aryl and halogen, and a charge transport layer comprising tri-p-toylamine and 1,-1-bis(N,N-ditoyl-4-aminophenyl)cyclohexane. The image forming apparatus includes a development component for applying a developer material to the charge-retentive surface to develop the electrostatic latent image to form a developed image on the charge-retentive surface. The image forming apparatus includes a transfer component for transferring the developed image from the charge-retentive surface to another member or a copy substrate and a fusing member to fuse the developed image to the copy substrate.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 shows a chart displaying strong absorption of light in the blue region of the spectrum of an embodiment for a charge generating layer having a phenethyl perylene pigment.

FIG. 2 shows a chart displaying weak absorption of light in the blue region of the spectrum for a charge generating layer having HOGaPc pigment.

FIG. 3 shows the spectral response of an embodiment of a charge generating layer having a phenethyl perylene pigment.

It should be noted that some details of the figures have been simplified and are drawn to facilitate understanding of the embodiments rather than to maintain strict structural accuracy, detail, and scale.

### DESCRIPTION OF THE EMBODIMENTS

In the following description, reference is made to the chemical formulas that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

Described herein is the incorporation of short wavelength sensitive perylene-tetracarbonic acid amide pigments into the charge generating layer of a photoreceptor. The described photoreceptor is useful in blue laser xerographic engines.

For the charge generating layer, perylene-tetracarbonic acid amide pigments shown in the formula below are used:

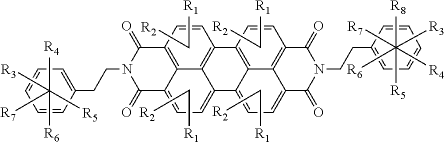

wherein R₁, R₂, R₃, R₄, R₅, R₆ and R₇ comprise a hydrogen, substituted or unsubstituted alkyl having about 1 to about 25 carbons, or from about 1 to about 10 carbon atoms, or from about 1 to about 5 carbon atoms. for example methyl, ethyl, propyl, butyl, pentyl and higher straight chained alkyl groups. R₁, R₂, R₃, R₄, R₅, R₆ and R₇ can comprise an aryl selected to contain from about 6 to about 48 carbon atoms. Selected examples of suitable aryl components include but are not limited to phenyl, naphthyl, anthranyl or higher fused aromatic ring systems. In further embodiments R₁, R₂, R₃, R₄, R₅, R₆ and R₇ can comprise a halogen selected to include but is not limited to fluorine, chlorine, bromine and iodine. In specific embodiments R₁, R₂, R₃, R₄, R₅, R₆ and R₇ are hydrogen etc.

Disclosed herein is a photoconductive member incorporating short wavelength sensitive perylene-tetracarbonic acid amide pigments into the charge generating layer of the photoreceptor to enable application of the photoreceptor in blue laser xerographic engines.

An exemplary compound phenethyl perylene in the class of perylene-tetracarbonic acid amide pigments can be synthesized and purified using the chemistry patented in U.S. Pat. No. 5,853,933 incorporated by reference in its entirety, and shown in Equation 1. Equation 1—Synthesis of short wavelength sensitive pigment phenethyl perylene.

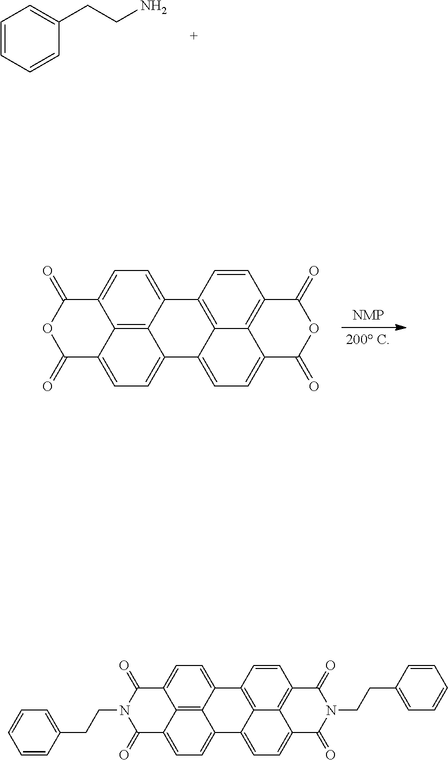 [SMILES: NCCc1ccccc1 ; O=C1OC(=O)c2ccc3c4ccc5c6c(ccc(c7ccc1c2c73)c64)C(=O)OC5=O ; O=C1c2ccc3c4ccc5c6c(ccc(c7ccc(c2c37)C(=O)N1CCc1ccccc1)c64)C(=O)N(CCc1ccccc1)C5=O]

In embodiments, there is provided a member wherein the charge generating layer is of a thickness of from about 0.1 microns to about 30 microns, or from about 0.2 microns to about 20 microns or about 1 micron to about 5 microns, wherein the charge generator component of perylene-tetracarbonic acid amide pigments is present in an amount from about 50 weight percent to about 90 weight percent, or from about 65 weight percent to about 85 weight percent or from about 75 weight percent to about 80 weight percent of the charge generating layer with from about 10 weight percent to about 50 weight percent of binder, and wherein the total of the components of the charge generating layer is 100 percent. The charge generating layer absorbs light of a wavelength of from about 350 nanometers to about 450 nanometers or about 370 nanometers to about 425 nanometers.

In embodiments there is disclosed an imaging member wherein the supporting substrate is comprised of a conductive substrate comprised of a metal; an imaging member wherein the conductive substrate is aluminum, aluminized polyethylene terephthalate or titanized polyethylene terephthalate; and an imaging member wherein the charge generator binder is selected from the group consisting of polyesters, polyvinyl butyrals, polycarbonates, polystyrene-b-polyvinyl pyridine, and polyvinyl formyls.

In embodiments, the imaging member includes a charge transport layer which is a hole transporting layer and is comprised of tri-p-tolylamine and 1,-1-bis(N,N-ditoyl-4-aminophenyl)cyclohexane charge transport molecules and wherein such a layer is transparent to radiation at between about 350 nanometers to about 700 nanometers. The hole transport layer includes tri-p-tolylamine and 1,-1-bis(N,N-ditoyl-4-aminophenyl)cyclohexane charge transport molecules in an amount from about 20 weight percent to about 60 weight percent or from about 35 weight percent to about 55 weight percent, or from about 45 weight percent to about 50 weight percent of the charge transport layer. The hole transport component of the transport layer includes from about 0 weight percent to about 100 weight percent, or from about 30 weight percent to about 70 weight percent, or from about 45 weight percent to about 55 weight percent of tri-p-tolylamine. The hole transport component of the transport layer includes from about 0 weight percent to about 100 weight percent, or from about 30 weight percent to about 70 weight percent, or from about 45 weight percent to about 55 weight percent of 1,-1-bis(N,N-ditoyl-4-aminophenyl)cyclohexane. The comprises of a thickness of from about 5 microns to about 40 microns, or from about 15 microns to about 35 microns, or about 25 microns to about 35 microns.

A method of imaging is provided which comprises generating an electrostatic latent image on the imaging member of the present disclosure, developing the latent image, and transferring the developed electrostatic image to a suitable substrate. The method includes exposing imaging member to light of a wavelength of from about 350 nanometers to about 450 nanometers or about 370 nanometers to about 425 nanometers.

In embodiments herein, there is provided an imaging apparatus containing a charging component, a development component, a transfer component, and a fixing component and wherein the apparatus contains a photoconductive imaging member comprised of supporting substrate, and thereover a layer comprised of a perylene-tetracarbonic acid amide pigment having the formula:

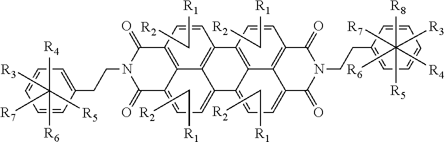

wherein R₁, R₂, R₃, R₄, R₅, R₆ and R₇ comprise a hydrogen, substituted or unsubstituted alkyl having from about 1 to about 25 carbons, or from about 1 to about 10 carbon atoms, or from about 1 to about 5 carbon atoms, for example methyl, ethyl, propyl, butyl, pentyl and higher straight chained alkyl groups. R₁, R₂, R₃, R₄, R₅, R₆ and R₇ can comprise aryl containing from about 6 to about 48 carbon atoms. Selected examples of suitable aryl components include but are not limited to phenyl, naphthyl, anthranyl or higher fused aromatic ring systems. In further embodiments, R₁, R₂, R₃, R₄, R₅, R₆ and R₇ can comprise halogen selected to include but is not limited to fluorine, chlorine, bromine and iodine. The photoconducting imaging member includes a charge transport layer. In specific embodiments R₁, R₂, R₃, R₄, R₅, R₆ and R₇ are hydrogen etc.

There is provided an imaging apparatus containing a charging component, a development component, a transfer component, and a fixing component, and wherein the apparatus contains a photoconductive imaging member comprised of supporting substrate, and thereover a charge generation layer and a charge transport layer as described herein wherein the imaging member further contains an adhesive layer and a hole blocking layer.

There is provided herein an imaging member wherein the blocking layer is contained as a coating on a substrate and wherein the adhesive layer is coated on the blocking layer; an imaging member further containing an adhesive layer and a hole blocking layer.

The photogenerating or charge generating components or pigments and the charge transport components are in embodiments dispersed in a suitable binder, for example a polymer binder, such as for example polyesters, polyvinyl butyrals, polycarbonates, polystyrene-b-polyvinyl pyridine, and polyvinyl formyls.

There can also be selected for members of the present disclosure a suitable adhesive layer, which can be for example situated between the substrate and the single layer, examples of adhesives being polyesters, such as VITEL® PE 100 and PE 200 available from Goodyear Chemicals or MOR-ESTER 49,0000® available from Norton International. This adhesive layer can be coated onto the supporting substrate from a suitable solvent, such as tetrahydrofuran and/or dichloromethane solution, to enable a thickness thereof ranging, for example, from about 0.001 microns to about 5 microns, and more specifically, from about 0.1 microns to about 3 microns.

The photoconductive imaging members can be economically prepared by a number of methods, such as the coating of the components from a dispersion, and more specifically, as illustrated herein. Thus, the photoresponsive imaging member disclosed herein can in embodiments be prepared by a number of known methods, the process parameters being dependent, for example, on the member desired. The charge generating pigments and charge transport components for the imaging members can be coated as solutions or dispersions onto a selected substrate by the use of a spray coater, dip coater, extrusion coater, roller coater, wire-bar coater, slot coater, doctor blade coater, gravure coater, and the like, and dried at from about 40° C. to about 200° C. for a suitable period of time, such as from about 10 minutes to about 10 hours under stationary conditions or in an air flow. The coating can be accomplished to provide a final coating thickness of from about 0.1 microns to about 30 microns after drying. The fabrication conditions for a given photoconductive layer can be tailored to achieve optimum performance and cost in the final members. The coating in embodiments can also be accomplished with spray, dip or wire-bar methods such that the final dry thickness of the charge generating layer is, for example, from about 0.1 microns to about 30 microns, or about 0.2 microns to about 20 microns, or about 1 micron to about 5 microns, after being dried at, for example, about 40° C. to about 150° C. for about 5 minutes to about 90 minutes. Likewise, the charge transport layer or hole transport layer can be coated and dried as described above such that the final dry thickness of the charge transport layer is, for example, from about 5 microns to about 40 microns, or from about 15 microns to about 35 microns, or about 25 microns to about 35 microns at about 40° C. to about 150° C. for about 5 minutes to about 90 minutes.

Examples of substrate layers selected for the present imaging members can be opaque or substantially transparent, and can comprise any suitable material having the requisite mechanical properties. Thus, the substrate can comprise a layer of insulating material including inorganic or organic polymeric materials, such as MYLAR®, a commercially available polymer, MYLAR® containing titanium, a layer of an organic or inorganic material having a semiconductive surface layer, such as indium tin oxide, or aluminum arranged thereon, or a conductive material inclusive of aluminum, chromium, nickel, brass or the like. The substrate may be flexible, seamless, or rigid, and may have a number of many different configurations, such as, for example, a plate, a cylindrical drum, a scroll, an endless flexible belt, and the like. In one embodiment, the substrate is in the form of a seamless flexible belt. In some situations, it may be desirable to coat on the back of the substrate, particularly when the substrate is a flexible organic polymeric material, an anticurl layer, such as, for example, polycarbonate materials commercially available as MAKROLON®.

The thickness of the substrate layer depends on many factors, including economical considerations, thus this layer can be of substantial thickness, for example, over 3,000 microns, or of a minimum thickness. In one embodiment, the thickness of this layer is from about 75 microns to about 300 microns.

In embodiments, layer coating solvents selected can include, for example, ketones, alcohols, aromatic hydrocarbons, halogenated aliphatic hydrocarbons, ethers, amines, amides, esters, and the like. Specific examples include, but are not limited to, cyclohexanone, acetone, methyl ethyl ketone, methanol, ethanol, butanol, amyl alcohol, toluene, xylene, chlorobenzene, carbon tetrachloride, chloroform, methylene chloride, trichloromethylene, tetrahydrofuran, dioxane, diethyl ether, dimethyl formamide, dimethyl acetamide, butyl acetate, ethyl acetate, methoxyethyl acetate, and the like.

As optional adhesives usually in contact with the supporting substrate, there can be selected various known substances inclusive of polyesters as indicated herein, polyamides, poly(vinyl butyral), poly(vinyl alcohol), polyurethane and polyacrylonitrile. This layer is of a suitable thickness, for example a thickness of from about 0.001 microns to about 1 micron. Optionally, this layer may contain effective suitable amounts, for example from about 1 weight percent to about 10 weight percent, of conductive and nonconductive particles, such as zinc oxide, titanium dioxide, silicon nitride, carbon black, and the like, to provide, for example, in embodiments, further desirable electrical and optical properties.

Further included are methods of imaging and printing with the photoresponsive or photoconductive members illustrated herein. These methods generally involve the formation of an electrostatic latent image on the imaging member, followed by developing the image with a toner composition comprised, for example, of thermoplastic resin, colorant, such as pigment, charge additive, and surface additives, referenced, for example in U.S. Pat. Nos. 4,560,635; 4,298,697; and 4,338,380, the disclosures of each of which are totally incorporated herein by reference, subsequently transferring the image to a suitable substrate, and permanently affixing, for example, by heat, the image thereto. In those environments wherein the member is to be used in a printing mode, the imaging method is similar with the exception that the exposure step can be accomplished with a laser device or image bar.

The layered photoconductive imaging members illustrated herein can be selected for a number of different known imaging and printing processes including, for example, multicopy/fax devices, electrophotographic imaging processes, especially xerographic imaging and printing processes wherein negatively charged or positively charged images are rendered visible with toner compositions of an appropriate charge polarity. The imaging members as indicated herein are in embodiments sensitive in the wavelength region of, for example, from about 900 to about 300 nanometers, and in particular, from about 350 to about 450 nanometers, or from about 370 nanometers to about 425 nanometers. Moreover, the imaging members of the present disclosure in embodiments can be selected for color xerographic imaging applications where several color printings can be achieved in a single pass. Xerographic imaging processes utilizing said short wavelength imaging members described herein enable higher print resolution and higher speed printing as compared to conventional longer wavelength imaging members. This is because the exposure systems in laser printers are diffraction limited and their performance depends on the wavelength of the laser that is used. Decreasing the exposure wavelength enables a reduction in aperture size, an increase in depth of field, and an increase in polygon facet number that enables increased print resolution and print speed. Therefore there is a need for an improved imaging member that has good photosensitivity at shorter wavelengths.

While embodiments have been illustrated with respect to one or more implementations, alterations and/or modifications can be made to the illustrated examples without departing from the spirit and scope of the appended claims. In addition, while a particular feature herein may have been disclosed with respect to only one of several implementations, such feature may be combined with one or more other features of the other implementations as may be desired and advantageous for any given or particular function.

### EXAMPLES

### Photoreceptor Device Fabrication

A charge generating layer was prepared by introducing into a glass amber bottle 0.2 gram of phenethyl perylene pigment with 0.05 gram of poly-N-vinylcarbazole (PVK) and 10.5 grams dichloromethane and 70 grams ⅛″stainless steel shots, then placing the bottle on a roll mill for 3 days with gentle to moderate rolling. Using a film applicator with a gap of 1.5 mil, the pigment dispersion was coated on a titanized MYLAR® substrate of 75 microns in thickness which substrate contained thereon a silane layer, 0.1 micron in thickness. Thereafter, the photogenerator layer formed was dried in a forced air oven at 135° C. for 20 minutes. A hole transport layer was prepared by introducing into a glass amber bottle 2.025 grams of polycarbonate (PC(Z)400) Bisphenol Z type polycarbonate resin available from Mitsubishi Gas, 1.35 grams of 1,1-bis-(N,N-ditoyl-4-aminophenyl)cyclohexane and 15.38 grams of methylene chloride. The resulting solution was coated onto the above photogenerating layer using a film applicator of 10 mil gap. The resulting photoconductive member was then dried at 135° C. in a forced air oven for 20 minutes. The final dried thickness of the transport layer was 30 microns. A separate device was fabricated for optical absorption testing comprising a clear mylar substrate and a charge generating layer the same as above.

The testing protocol for the charge generating layer is described. Optical absorption was measured using a UV spectrometer. Spectral response and xerographic charge-discharge performance under blue light were measured using a flat plate scanner capable of variable exposure wavelengths.

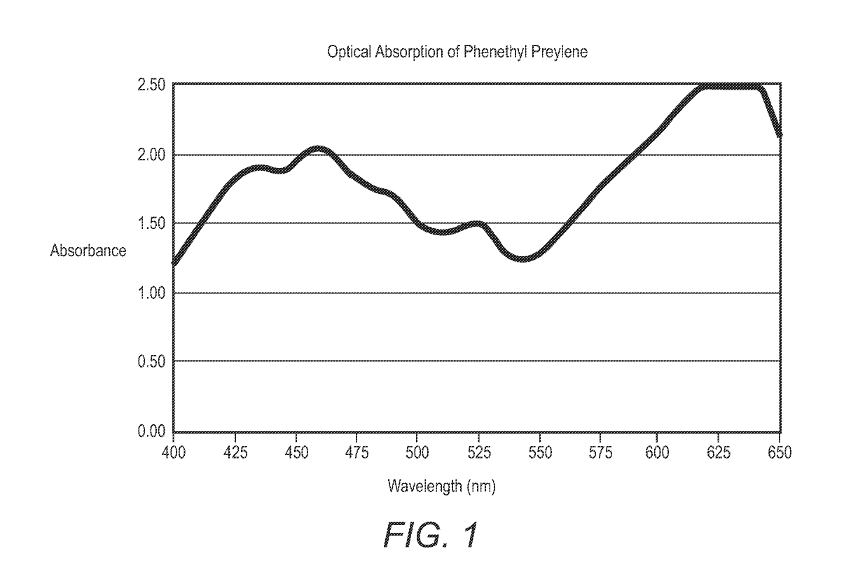

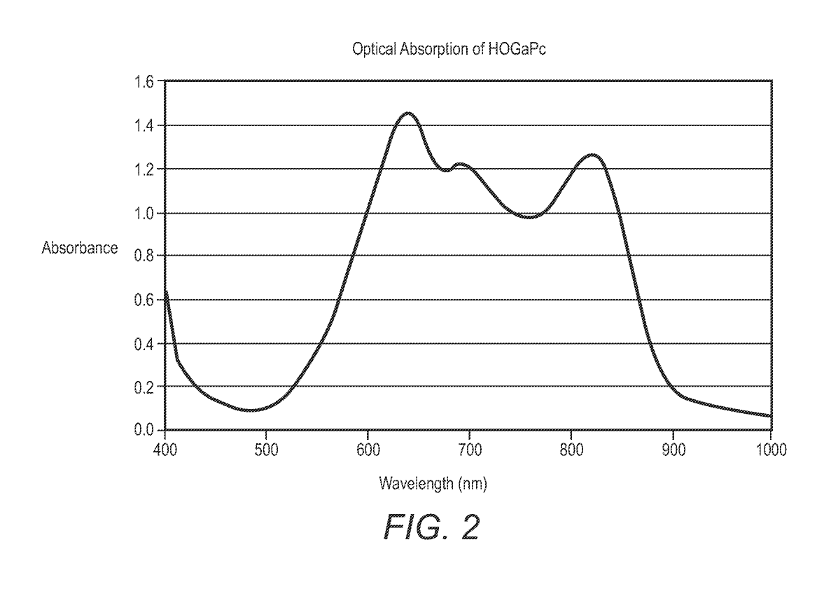

Optical absorption of a phenethyl perylene (left) charge generating layer displaying strong absorption of light in the blue region of the spectrum is shown in FIG. 1. Conventional HOGaPc pigment displaying poor absorption in the blue region of the spectrum is shown in FIG. 2.

Spectral response and xerographic charge-discharge performance of the above-prepared photoconductive imaging members was determined by electrostatically charging the surfaces thereof with a corona discharge source until the surface potentials, as measured by a capacitively coupled probe attached to an electrometer, attained an initial value Vo of about −800 volts. After resting for 0.5 second in the dark, the charged members attained a surface potential of Vddp, dark development potential. Vo−Vddp is the Dark Decay. Each member was then exposed to light from a filtered Xenon lamp thereby inducing a photodischarge which resulted in a reduction of surface potential to a Vbg value, background potential. The photosensitivity of the imaging member was usually provided in terms of the amount of exposure in ergs/cm², designated as E_{1/2}, required to achieve 50 percent photodischarge from V_{ddp} to half of its initial value. The desired wavelength and energy of the exposed light was determined by the type of filters placed in front of the lamp. The monochromatic light photosensitivity was determined using a narrow band-pass filter. The imaging members were tested at various light energy levels to produce a photoinduced discharge curve PIDC. The initial slope of this curve S(Vergs/cm²) starting at 0 ergs/cm² and increasing was determined to give an indication of the readiness of surface potential drop under light exposure. PIDC and S values were obtained with an exposure of monochromatic light at wavelengths ranging from 400 nanometers to 625 nanometers to produce a spectral response curve.

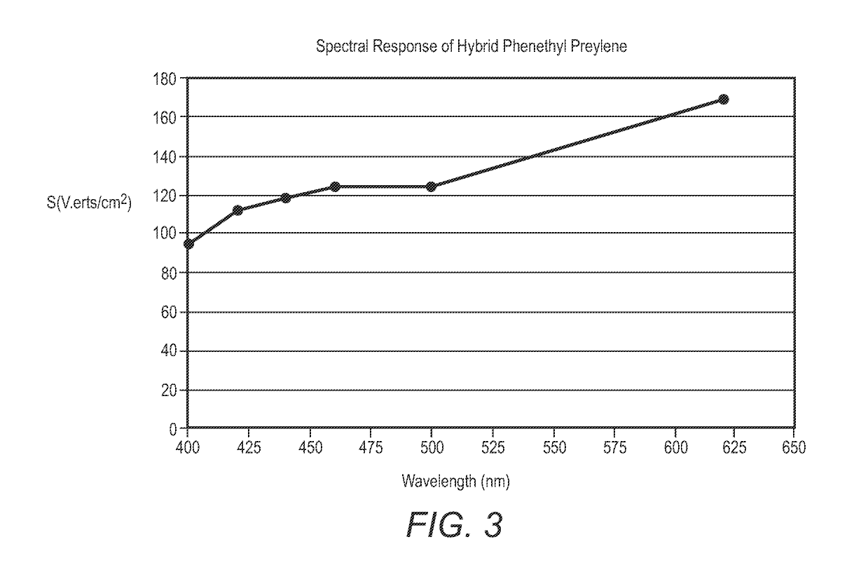

FIG. 3 shows the spectral response of photoreceptor comprising phenethyl perylene pigment 1,-1-bis(N,N-ditoyl-4-aminophenyl)cyclohexane demonstrating strong photosensitivity even at shorter wavelengths required for blue laser xerography.

Charge-discharge performance for a photoreceptor comprising phenethyl perylene pigment and 1,-1-bis(N,N-ditoyl-4-aminophenyl)cyclohexane measured at various exposure wavelengths is summarized in Table 1. Table 1 demonstrates excellent performance including photosensitivity (E1/2) and initial PIDC slope (S) even at shorter wavelengths required for blue laser xerography.

TABLE 1

| Expose | Dark Decay | S | E_{1/2} | E_{7/8} | |
|---|---|---|---|---|---|
| (nm) | (500 ms) (V) | (V · erg/cm²) | (ergs/cm²) | (ergs/cm²) | Vᵣ |
| 400 | 2.2 | 95 | 4.80 | 12.17 | 14 |
| 420 | 1.9 | 113 | 4.20 | 10.48 | 18 |
| 440 | 2.3 | 119 | 3.94 | 9.68 | 18 |
| 460 | 2.0 | 124 | 3.76 | 9.17 | 19 |
| 500 | 2.4 | 124 | 3.85 | 9.63 | 17 |
| 620 | 1.4 | 168 | 2.63 | 6.29 | 19 |

It will be appreciated that variants of the above-disclosed and other features and functions or alternatives thereof, may be combined into other different systems or applications. Various presently unforeseen or unanticipated alternatives, modifications, variations, or improvements therein may be subsequently made by those skilled in the art which are also encompassed by the following claims.

What is claimed is:

1. A photoconductive member comprising:
a conductive support and disposed thereon a charge generating layer comprising a first polymer binder and a perylene-tetracarbonic acid amide having blue wavelength photosensitivity of the following formula: 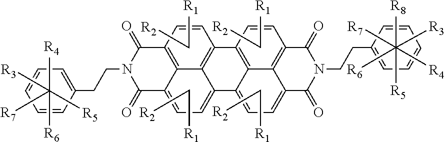
wherein each of R₁, R₂, R₃, R₄, R₅, R₆ and R₇ are the same or different and are independently selected from the group comprising hydrogen, alkyl, aryl and halogen; and
a charge transport layer comprising tri-p-toylamine and 1,-1-bis(N,N-ditoyl-4-aminophenyl)cyclohexane in a second polymer binder disposed on the charge generating layer.

2. The photoconductive member of claim 1, wherein the charge generating layer comprises a thickness of from about 0.1 microns to about 30 microns.

3. The photoconductive member of claim 1, wherein the charge transport layer having a thickness of from about 5 microns to about 40 microns.

4. The photoconductive member of claim 1, wherein the perylene-tetracarbonic acid amide is present in an amount of from about 50 weight percent to about 90 weight percent of the charge generating layer.

5. The photoconductive member of claim 1, wherein the charge generating layer absorbs light of a wavelength of from about 350 nanometers to about 450 nanometers.

6. The photoconductive member of claim 1, wherein the conductive support is comprised of a metal.

7. The photoconductive member of claim 6 wherein the metal is selected from the group consisting of aluminum, aluminized polyethylene terephthalate and titanized polyethylene terephthalate.

8. The photoconductive member of claim 1, wherein the first polymer binder is selected from the group consisting of polyesters, polyvinyl butyrals, polycarbonates, polystyrene-b-polyvinyl pyridine, and polyvinyl formyls.

9. The photoconductive member of claim 1, wherein the second polymer binder is selected from the group consisting of polyesters, polyvinyl butyrals, polycarbonates, polystyrene-b-polyvinyl pyridine, and polyvinyl formyls.

10. The photoconductive member of claim 1, further comprising an adhesive layer and a hole blocking layer.

11. The photoconductive member of claim 1, wherein the tri-p-toylamine and 1,-1-bis(N,N-ditoyl-4-aminophenyl)cyclohexane are present in an amount of from 20 weight percent to about 60 weight percent of the charge transport layer.

12. A method of imaging which comprises generating an electrostatic latent image on the photoconductive member of claim 1, developing the latent image, and transferring the developed electrostatic image to a suitable substrate.

13. The method of claim 12, wherein the photoconductive member is exposed to light of a wavelength of from about 370 nanometers to about 425 nanometers.

14. A photoconductive member comprising:
a conductive support and disposed thereon a charge generating layer comprising a having blue wavelength photosensitivity of the following formula: 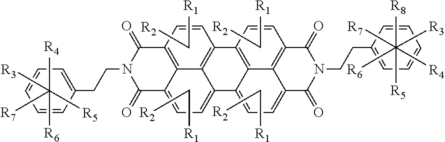
wherein each of R₁, R₂, R₃, R₄, R₅, R₆ and R₇ are the same or different and are independently selected from the group comprising hydrogen, alkyl, aryl and halogen; and
a charge transport component comprising 1,-1-bis(N,N-ditoyl-4-aminophenyl) cyclohexane disposed on the charge generating layer.

15. The photoconductive member of claim 14, wherein the charge generating layer further comprises a binder selected from the group consisting of polyesters, polyvinyl butyrals, polycarbonates, polystyrene-b-polyvinyl pyridine, and polyvinyl formyls.

16. The photoconductive member of claim 14, wherein the charge transport layer further comprises a binder selected from the group consisting of polyesters, polyvinyl butyrals, polycarbonates, polystyrene-b-polyvinyl pyridine, and polyvinyl formyls.

17. The photoconductive member of claim 13 wherein the conductive support is selected from the group consisting of aluminum, aluminized polyethylene terephthalate and titanized polyethylene terephthalate.

18. The photoconductive member of claim 14, further comprising an adhesive layer and a hole blocking layer.

19. An image forming apparatus for forming images on a recording medium comprising:
a) a photoreceptor member having a charge retentive surface to receive an electrostatic latent image thereon, wherein said photoreceptor member comprises a supporting substrate and thereover a charge generating layer comprising a blue wavelength photosensitivity of the following formula: 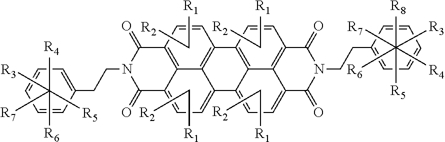
wherein each of R₁, R₂, R₃, R₄, R₅, R₆ and R₇ are the same or different and are independently selected from the group comprising hydrogen, alkyl, aryl and halogen;
and a charge transport layer comprising 1,-1-bis(N,N-ditoyl-4-aminophenyl) cyclohexane in a second polymer binder disposed on the charge generating layer;
b) a development component to apply a developer material to said charge-retentive surface to develop said electrostatic latent image to form a developed image on said charge-retentive surface;
c) a transfer component for transferring said developed image from said charge-retentive surface to another member or a copy substrate; and
d) a fusing member to fuse said developed image to said copy substrate.

20. The image forming apparatus of claim 19, wherein the charge generating layer comprises
a thickness of from about 0.1 microns to about 30 microns.
